(19) United States
(12) Patent Application Publication
(10) Pub. No.: US 2017/0212087 A1
(43) Pub. Date: Jul. 27, 2017

(54) CHAMBERED ION REFLUX SYSTEM FOR ION CHROMATOGRAPHY, APPARATUS AND METHOD OF USE

(71) Applicant: John M RIVIELLO, Los Gatos, CA (US)

(72) Inventor: John M. Riviello, Los Gatos, CA (US)

(21) Appl. No.: 15/530,578

(22) PCT Filed: Aug. 18, 2015
(86) PCT No.: PCT/US15/00086

§ 371 Date: Jan. 31, 2017

Related U.S. Application Data
(60) Provisional application No. 62/070,283, filed on Aug. 21, 2014.

(51) Int. Cl. G01N 30/96; B01D 15/16; B01D 15/36

(52) U.S. Cl. CPC G01N 30/96; B01D 15/361; B01D 15/166

(57) ABSTRACT

A chambered ion reflux device for ion chromatography which electrolytically produces an eluent from a water pumped phase, suppresses the eluent and recovers (refluxes) the eluent ions for reuse. In the chambered ion reflux device, the eluent never passes through the electrode chambers. Since the eluent ions are refluxed and the eluent is produced electrolytically, the chambered ion reflux device can be used for isocratic or gradient ion chromatography. A chambered ion reflux device which integrates an electrolytic ion removal chamber is also disclosed.

### BACKGROUND OF THE INVENTION

Electrolytic ion exchange devices have been used in Ion Chromatography (IC) for more than 35 years. The first electrolytic devices were suppressors which served to reduce the background conductivity of the eluent, while at the same time increasing the conductivity of the analytes being measured. Such suppressors are described in U.S. Pat. No. 4,459,357, U.S. Pat. No. 5,248,426 and U.S. Pat. No. 5,633,171. Just as electrolytic suppressors can be used to remove eluent ions, devices referred to as eluent generators can be used to electrolytically add ions to water for the production of an acid or base eluent. Electrolytic eluent generators have also been developed and allow the production of eluent using water as the pumped phase as described in U.S. Pat. No. 6,955,922. In these eluent generators, a large reservoir of the eluent ion is separated from the flow through generator chamber by an ion exchange barrier. The eluent ion reservoir and the generator chamber each contain an electrode. When a DC voltage is applied to the electrodes, electrolysis occurs in the eluent reservoir and eluent ions migrate from the reservoir, through the ion exchange barrier or membrane and into the flow chamber. In the flow chamber, water is also electrolyzed producing hydroxide or hydronium ions which then combine with the eluent ion to form the eluent. The current applied to the electrolytic eluent generator and the water flow rate determines the concentration of eluent produced. In these types of eluent generators, the eluent is used once and then disposed of as waste. Electrolytic devices which can purify an acid or base eluent have also been developed as described in U.S. Pat. No. 5,045,204 and U.S. Pat. No. 7,704,749.

While most electrolytic devices perform a single function in ion chromatography such as eluent generation and suppression, a technique referred to as ion reflux integrates into a single device chromatographic separation, electrolytic eluent generation and suppression as described in U.S. Pat. No. 5,914,025. In U.S. Pat. No. 6,027,643, an ion reflux device is described which removes the separator function from the ion reflux device. Ion reflux has been demonstrated for both anion and cation analysis. One of the unique properties of ion reflux is that the eluent ion, for example potassium, used for electrolytic generation of potassium hydroxide, is refluxed or recycled in the device. The source of the eluent ion originates in the ion reflux device. For each equivalence of potassium hydroxide produced, an equivalence of potassium hydroxide is suppressed, i.e., neutralized, and as a result of the suppression reaction, the potassium ion is conserved (refluxed) in the ion reflux device. In ion reflux, eluent generation and suppression are stoichiometrically linked. Using only water as the pumped phase, ion reflux allows for both isocratic and gradient analysis by controlling the electrical current supplied to the device. In addition to refluxing the eluent ion, the water used for eluent generation can also be recycled.

In ion reflux, the electrode reactions produce electrolysis gases (hydrogen and oxygen), and one or both of these gases are carried through the chromatographic system. These gases can compromise the performance of the system by causing pump flow irregularity and interfering with conductivity detection. In addition, electrochemical by-products of electrolysis such as hydrogen peroxide and ozone can cause chemical degradation of critical components, such as the separator in the chromatographic system. Thus, there is a need for an ion reflux system in which the pumped phase or eluent does not pass through the electrode chambers.

In U.S. Paat. No. 7,329,346, an apparatus and methods for catalytic gas elimination and eluent recycle are described. In eluent recycle, a manually prepared eluent is pumped through the chromatographic system. During suppression, the eluent ions are electrolytically removed into an electrode chamber. The suppressed eluent is then directed to the electrode chamber where the eluent is reformed and returned to the eluent container. Since the electrode chambers produce hydrogen and oxygen, catalytic elimination of the hydrogen and oxygen gases is used. The catalytic recombination of oxygen and hydrogen to water eliminates problems associated with dissolved gases in the eluent stream and aids in reducing electrolytic by products such as ozone and hydrogen peroxide. In U.S. Pat. No. 8,597,571, an electrolytic eluent recycle apparatus and method is described in which the recycled eluent does not pass through the electrode chambers, thereby reducing problems associated with the electrolysis gases and electrochemical by-products.

### SUMMARY OF THE INVENTION

One embodiment of the present invention is a chambered ion reflux apparatus for ion chromatography comprising: a first electrode chamber comprising a first electrode and including an inlet and an outlet; an eluent generator chamber comprising ion exchange material and including an inlet and an outlet; a suppressor chamber comprising flow-through ion exchange material and including an inlet and an outlet; a second electrode chamber comprising a second electrode and including an inlet and an outlet; a first barrier preventing significant liquid flow, but permitting transport of ions of only one charge, positive or negative, disposed between said eluent generator chamber and said first electrode chamber; a second barrier preventing significant liquid flow, but permitting transport of ions of only one charge, positive or negative, disposed between said eluent generator chamber and said suppressor chamber; a third barrier preventing significant liquid flow, but permitting transport of ions of only one charge, positive or negative, disposed between said second electrode chamber and said suppressor chamber; and the outlet of the suppressor chamber being in liquid communication in a sequence selected from the group consisting of first through the anode chamber and then through the cathode chamber, first through the cathode chamber and then through the anode chamber and through both the anode chamber and the cathode chamber.

In another embodiment the present invention is an ion chromatography method using a chambered ion reflux device for ion chromatography comprising an eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first electrode chamber, and a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, said method comprising the steps of: (a) flowing deionized water through said eluent generator chamber to generate an acid or base eluent; (b) flowing said acid or base eluent through said suppressor chamber to neutralize said eluent to generate a neutralized eluent; (c) flowing said neutralized eluent in a sequence selected from the group consisting of through first through the anode chamber and then through the cathode chamber, through the first the cathode chamber and then through the anode chamber and through both the anode chamber and the cathode chamber; and (d) passing a current between said first and second electrodes through said eluent generator chamber and said suppressor chamber during steps (a) through (c).

In yet another embodiment the instant invention is an ion reflux apparatus for ion chromatography comprising an eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first electrode chamber, a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, an ion removal chamber comprising ion exchange material disposed between said second electrode chamber and said suppression chamber, and a fourth barrier preventing significant liquid flow disposed between said ion removal chamber and said suppressor chamber, but permitting transport of ions of only one charge, positive or negative.

In yet another embodiment the instant invention is an ion chromatography method using a chambered ion reflux device for ion chromatography comprising an eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first electrode chamber, a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, an ion removal chamber comprising ion exchange material disposed between said second electrode chamber and said suppression chamber, and a fourth barrier preventing significant liquid flow disposed between said ion removal chamber and said suppressor chamber, but permitting transport of ions of only one charge, positive or negative, said method comprising the steps of: (a) flowing deionized water through said eluent generator chamber to generate an acid or base eluent; (b) flowing said acid or base eluent through said suppression chamber to neutralize said eluent; (c) flowing said neutralized eluent through said ion removal chamber and then in a sequence selected from the group consisting of through first through the anode chamber and then through the cathode chamber, through the first the cathode chamber and then through the anode chamber and through both the anode chamber and the cathode chambers; and (d) passing a current between said first and second electrodes through said suppressor chamber, ion removal chamber, and eluent generator chamber, during steps (a) through (c).

A further embodiment of the present invention is an ion chromatography method using a chambered ion reflux device for ion chromatography comprising a eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first cicctrode chamber, a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, an ion removal chamber comprising ion exchange material disposed between said second electrode chamber and said suppression chamber, and a fourth barrier preventing significant liquid flow, but permitting transport of ions of only one charge, positive or negative disposed between said ion removal chamber and said suppressor chamber, said method comprising the steps of: (a) flowing deionized water from a first deionized water reservoir through said eluent generator chamber to generate an acid or base eluent; (b) flowing said acid or base eluent through said suppression chamber to neutralize said eluent; (c) flowing said neutralized eluent through said ion removal chamber and then back to said first deionized water reservoir; (d) flowing deionized water from a second deionized water reservoir in a sequence selected from the group consisting of first through the anode chamber, then through the cathode chamber and then back to the second deionized water reservoir and first the cathode chamber, then through the anode chamber and then back to said second deionized water reservoir; and (e) passing a current between said first and second electrodes through said suppressor chamber, ion removal chamber, and eluent generator chamber, during steps (a) through (d).

In another embodiment the instant invention is an apparatus for chambered ion reflux ion chromatography of ions to be analyzed using an eluent comprising an ion or ions having the same charge as the ions to be analyzed and a counter-ion or counter-ions of opposite charge, said apparatus comprising: a first electrode chamber comprising a first electrode and including an inlet and an outlet; an eluent generator chamber comprising ion exchange material and including an inlet and an outlet; a suppressor chamber comprising flow-through ion exchange material and including an inlet and an outlet; a second electrode chamber comprising a second electrode and including an inlet and an outlet; a first barrier preventing significant liquid flow, but permitting transport of ions of only one charge, positive or negative, disposed between said eluent generator chamber and said first electrode chamber; a second barrier preventing significant liquid flow, but permitting transport of ions of only one charge, positive or negative, disposed between said eluent generator chamber and said suppressor chamber; third barrier preventing significant liquid flow, but permitting transport of ions of only one charge, positive or negative, disposed between said second electrode chamber and said suppressor chamber; and wherein said flow-through ion exchange material of said suppression chamber adjacent said second barrier is in the ion form of the counter-ion or counter-ions of the eluent.

### BRIEF DESCRIPTION OF THE DRAWINGS

FIGS. 1-9 are schematic representations of different apparatus embodiments of the present invention; and

FIGS. 10-15 depict experimental results using selected apparatus of one of FIGS. 1-9.

### DETAILED DESCRIPTION

Chambered ion reflux devices are disclosed herein in which water is used as the pumped phase to electrolytically generate eluent and suppresses the eluent without the production of electrolysis gases or electrochemical by-products in the analytical stream. In the present invention, the pumped phase, eluent and suppressed eluent do not pass through the electrode chambers. The present invention relates to improvements in ion reflux devices which use water as the pumped to generate eluent (e.g. an acid or a base) and suppression for sample ions of one charge, positive or negative, to be chromatographically separated in an ion chromatograph (IC) system. The eluent ions are refluxed or recycled in the devices of the present invention. Integrated devices which combine suppression with other operations are disclosed in U.S. Pat. Nos. 5,914,025, 6,027,643 and 6,508,985; 8,597,571 and U.S. patent application Ser. No. 14/093,691 collectively “the prior art integrated device publications,” and incorporated by reference herein for their disclosures of operation and construction, including details of suitable barrier and ion exchange materials.

The term “ion exchange materials” refers to ion exchange resins, e.g. ion exchange particles in an ion exchange particle bed, ion exchange fibers, ion exchange screens, or ion exchange monoliths. Typically, one of two types of ion exchange materials are used, anion exchange materials and cation exchange materials (i.e. ones with anion and/or cation exchangeable ions) such as disclosed in the prior art integrated device publications. Anion and cation exchange materials may be mixed to produce a mixed ion exchange material, e.g. in a mixed packed bed of anion and cation particles. Typically, the cation exchange material is a strong acid ion exchanger, i.e., a material containing sulfonic acid groups, and the anion exchange material is a strong base ion exchange containing quaternary amine groups. Preferably, the ion exchange materials are conductive so that ions may migrate through the ion exchange material towards the respective electrodes.

The invention uses a number of barriers which prevent significant liquid flow but which ideally permit the transport of ions of only one charge, positive or negative, preferably through exchangeable ions on the barriers. Suitably such barriers are ion exchange membranes of one of two types, anion or cation exchange (i.e. ones with exchangeable anions or cations as disclosed in the prior art integrated device publications). These ion exchange membranes typically have strongly basic or strongly acidic functional groups. An anion exchange membrane will ideally transport only anions through the membrane, while the membrane prevents the bulk flow of liquid from one side of the membrane to the other. A cation exchange membrane will transport only cations through the membrane, while the membrane prevents the bulk flow of liquid from one side of the membrane to the other. Thus, preferably the membranes are conductive so that ions may migrate through the ion exchange membrane towards their respective electrodes. The invention will be described using ion exchange membranes as such barriers. The ions to be analyzed using the apparatus and method of the instant invention are typically eluted through a chromatographic separator column using an eluent comprising an ion or ions having the same charge, positive or negative, as the ions to be analyzed and a counter-ion or counter-ions of opposite charge. Preferably, the flow-through ion exchange material of the suppression chamber of the instant invention adjacent the barrier between the suppression chamber and the eluent generation chamber is in the ion form of the counter-ion or counter-ions of the eluent.

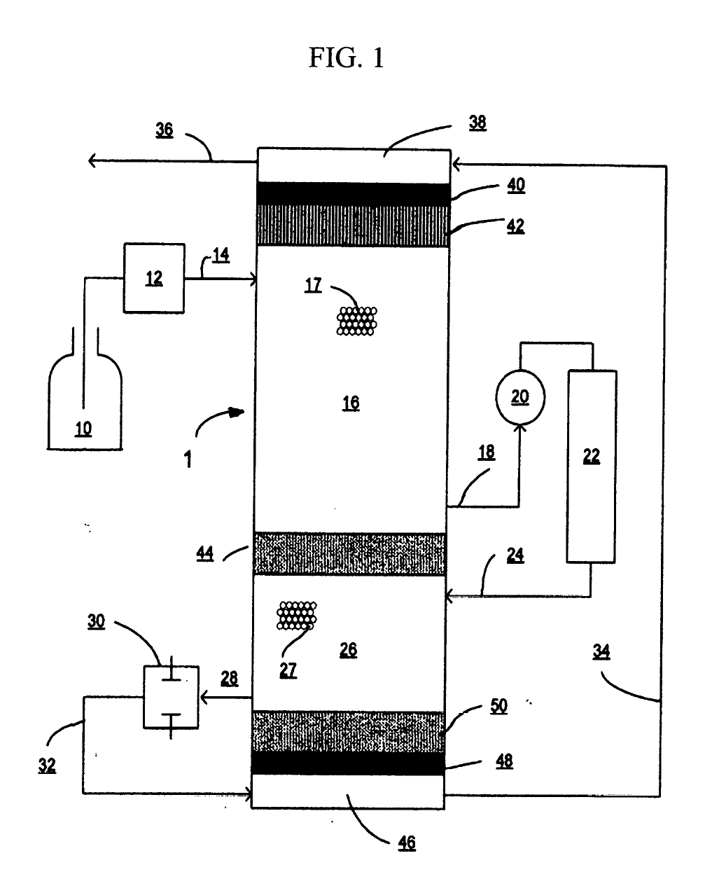

FIG. 1 shows one embodiment of a device to be used for anion analysis. The ion reflux device 1 has four discrete chambers. It includes a first electrode chamber in the form of a cathode chamber 38 containing cathode 40 and defined on one side by an anion exchange barrier 42 separating the cathode chamber 38 from eluent generation chamber 16. Eluent generation chamber 16 may be filled with a cation exchange, anion exchange or a composite of anion and cation exchange material, 17 (e.g. Dowex 50WX8 cation exchange resin, Dowex 1X8 anion exchange resin or a composite of the two resin types). The eluent generator generates a base to replenish part or all of the base eluent to be supplied to a chromatographic separator. A first cation exchange barrier 44 separates eluent generation chamber 16 from the suppression chamber 26. Suppression chamber 26 contains a strong cation exchange material 27 (e.g. Dowex 50WX8 cation exchange resin), the ion exchange capacity of which is at least partially in the cation form of the eluent. A second cation barrier 50 separates the suppression chamber 26 from a second electrode chamber in the form of an anode chamber 46, containing anode 48.

To further detail the device of FIG. 1, an example using water as the pumped phase with electrolytic generation and suppression of a KOH eluent will now be described. A deionized water source, 10, is directed to a pump, 12 via a conduit and the pump outlet conduit 14 directed to the fluid inlet of eluent generation chamber 16. The eluent generation chamber 16 contains cation exchange material, anion exchange or a composite of anion and cation exchange materials 17 in which the cation exchange material, is substantially in the potassium form and the anion exchange material if present is substantially in the hydroxide form. In cathode chamber 38, water is electrolyzed (reduced) at cathode 40 producing hydroxide (OH⁻) and hydrogen gas. As a result of the applied electric field, the hydroxide ions migrate through anion exchange barrier 42 into eluent generation chamber 16 where the hydroxide combines with potassium ions to generate the KOH eluent.

The solution exiting eluent generation chamber, 16 is the newly formed KOH eluent which flows via conduit 18 to injection valve 20 and then to chromatographic separator 22 e.g. a chromatography column in which ions of one charge, positive or negative, are separated). From the separator 22 the KOH eluent enters via conduit 24 into suppression chamber 26. Suppression chamber 26 contains high capacity cation exchange material 27 which suppress the KOH eluent to water. In the suppression reaction, potassium ions are exchanged for hydronium ions in the high capacity cation material 27. In anode chamber 46 water is electrolyzed (oxidized) to hydronium (H+) and oxygen gas at anode 48. As a result of the applied electric field, the hydronium ions migrate through cation exchange barrier 50 and into suppression chamber 26. For every equivalence of hydronium ion produced, an equivalence of potassium ion exits suppression chamber 26, through cation exchange barrier 44 and into eluent generation chamber 16 where the potassium ions can be used to produce KOH eluent. Hence, the potassium ion is continually refluxed between suppression chamber 26 and eluent generation chamber 16. For every equivalence of hydroxide ions produced in cathode chamber 38 there is an equivalence of hydronium ions produced in anode chamber 46 which results in the stoichiometrically linked eluent generation and suppression reactions.

The suppressed (i.e., neutralized) eluent exits suppression chamber 26 via conduit 28 where ions are detected via conductivity cell 30. More specifically, as illustrated for anion analysis in FIG. 1, the suppressed eluent exits conductivity cell 30 via conduit 32 to the inlet of anode chamber 46. This suppressed eluent serves as the source of water for the electrolysis reaction at anode 48 which produces the hydronium ion used for the suppression reaction in suppression chamber 26. The suppressed eluent (now containing hydrogen gas) exits anode chamber 46 via conduit 34 and the flow is directed to cathode chamber 38. In cathode chamber 38, the suppressed eluent serves as the source of water for the electrolysis reaction at cathode 40 which produces the hydroxide used for the eluent generation reaction in eluent generation chamber 16. The suppressed eluent and hydrogen gas exit cathode chamber 38 via conduit 36 and are directed to waste.

The anode chamber 46 contains an electrode 48 which is connected with electrode 40 in chamber 38. A power supply connected to electrodes 48 and 40 creates electrodes of opposite charge and an electric current is passed between the electrodes through all barriers and chambers of the device. As illustrated, electrode 48 is an anode and electrode 40 is a cathode. Electrode 48 is separated from suppression chamber 26 by barrier 50 illustrated as an cation exchange membrane of opposite charge to anion exchange membrane barrier 42 adjacent to cathode chamber 38.

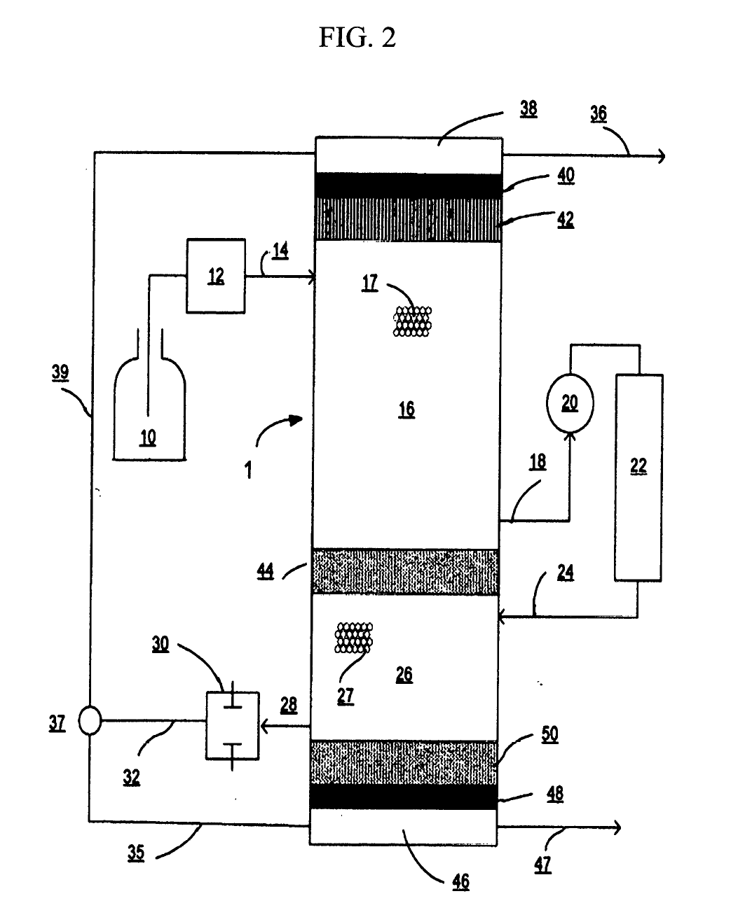

The electrode rinse solution may be the suppressed eluent as illustrated in FIG. 1 wherein the suppressed eluent exits conductivity cell 30 via conduit 32 which directs flow to the anode chamber 46 to conduit 34 and cathode chamber 38 to conduit 36 and to waste. In an alternative configuration, not shown, the rinse solution may flow in the opposite direction between chambers 46 and 38. In FIG. 2, the suppressed eluent from conductivity cell 30 is directed to a flow through tee 37 which splits the flow. One outlet of the tee 37 is connected to anode chamber 46 via conduit 35 and to waste via conduit 47. The other outlet of the tee 37 is connected to cathode chamber 38 via conduit 39 and to waste via conduit 36. An advantage of a single rinse stream flowing sequentially between the electrode chambers as depicted in FIG. 1 versus flowing in parallel as shown in FIG. 2 is that the flow rate as depicted in FIG. 1 is equal through both electrode chambers.

In the examples of FIGS. 1 and 2, the electrode rinse solution is isolated from the pumped phase, eluent and suppressed eluent. Thus, anion exchange barrier 42 and cation exchange barrier 50 substantially isolates the hydrogen, oxygen and electrochemical by-products from the eluent generation chamber 16 and the suppression chamber 26, respectively. As a result, electrochemical eluent generation and suppression occur without having to cope with electrolysis gases or by-products in the analytical stream.

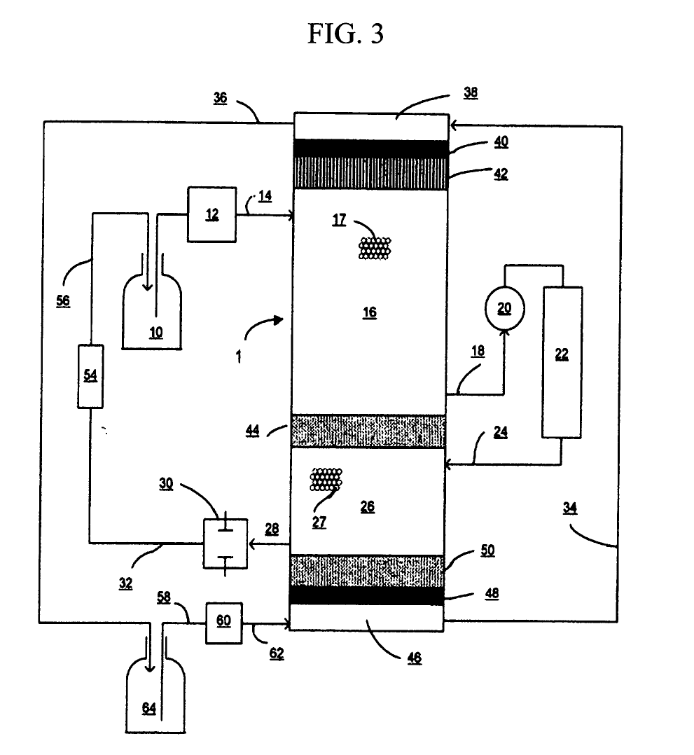

The ion reflux device 1 can be used in a pumped phase recycle mode. For anion analysis as shown in FIG. 3, the suppressed eluent exiting conductivity cell 30 via conduit 32 passes through an anion trap column 54 to conduit 56 which returns the suppressed eluent to the deionized water source 10. The anion trap column 54 removes trace anions from the suppressed eluent and could contain high capacity anion exchange resin material in the hydroxide from, e.g. in a packed bed, so that the lifetime of the trap could be very long. In addition to removing analytes from the recycled eluent, the anion trap column 54 could also be designed to trap anionic oligomers leaching from the sulfonated cation exchange materials of the suppression chamber 26 and eluent generation chamber 16. In this mode, the deionized water (pumped phase) will not contain oxygen, hydrogen and has no appreciable concentrations of electrochemical by-products and thus can recycled back to the deionized water source 10.

In FIG. 3, a second deionized water source is required for electrode rinse liquid. The electrode rinse liquid is typically deionized water and serves as a source of water for electrolysis to produce hydronium at the anode and hydroxide at the cathode. As shown in FIG. 3, an electrode rinse water source 64 is directed to a pump, 60 via conduit 58 and the pump outlet conduit 62 directed to the fluid inlet of anode chamber 46 and to conduit 34 which directs flow to cathode chamber 38 and then to conduit 36 which directs the electrode rinse water back to the source 64. In this way, the electrode rinse solution is recycled. The electrode rinse water source 64 is vented to prevent the accumulation of hydrogen and oxygen gases from the electrolysis of the water. In the system of FIG. 3 all liquids are recycled as well as the potassium for eluent generation. This system is ideally suited for long-term operation where minimal user intervention is required.

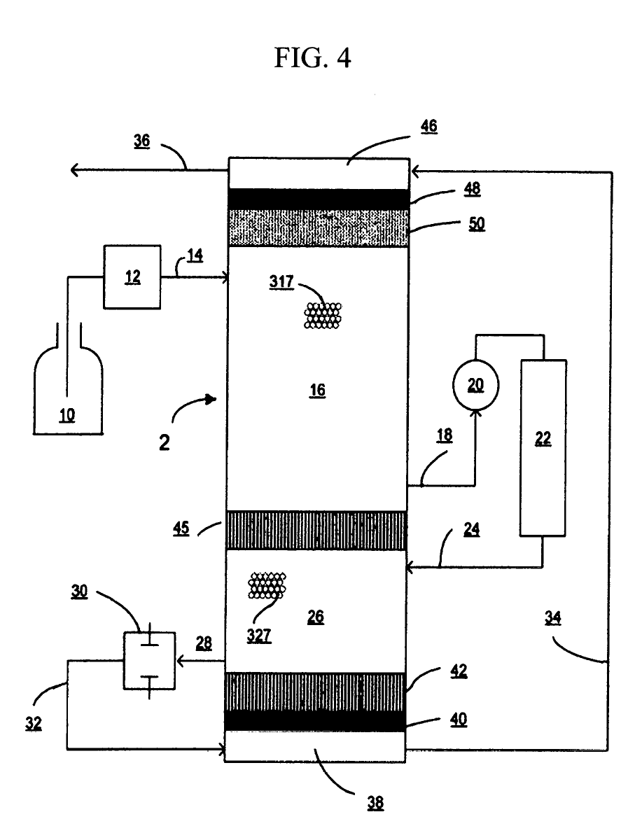

In FIG. 4, a device similar to that of FIG. 1 is illustrated with like parts designated with like numbers. FIG. 4 shows one embodiment of a device to be used for cation analysis. The ion reflux device 2 has four discrete chambers including a first electrode chamber in the form of an anode chamber 46 containing anode 48 and defined on one side by a cation exchange barrier 50 separating the anode chamber 46 from eluent generation chamber 16. Eluent generation chamber 16 may be filled with a anion exchange material or a composite of anion and cation exchange material 317 (e.g. Dowex 50WX8 cation exchange resin, Dowex 1X8 anion exchange resin or a composite of the two resin types). The eluent generator generates an acid to replenish part or all of the acid eluent to be supplied to a chromatographic separator 22. A first anion exchange barrier 45 separates eluent generation chamber 16 from suppression chamber 26. Suppression chamber 26 may be filled with a strong anion exchange material 30 (e.g. Dowex 1WX8 anion exchange resin) 327 the ion exchange capacity of which is at least partially in the anion form of the eluent. A second anion exchange barrier 42 separates the suppression chamber 26 from a second electrode chamber in the form of cathode chamber 38, containing cathode 40.

To further detail the device of FIG. 4, an example using water as the pumped phase with electrolytic generation and suppression of a methane sulfonic acid (MSA) eluent is described. A deionized water source, 10, is directed to a pump, 12 via a conduit and the pump outlet conduit 14 directed to the fluid inlet of eluent generation chamber 16. The eluent generation chamber 16 contains cation exchange material, anion exchange or a composite of anion and cation exchange materials 317 in which the anion exchange material, is substantially in the methane sulfonate form and the cation exchange material is substantially in the hydronium form. In anode compartment, 46, water is electrolyzed (oxidized) at anode 48, producing hydronium (H⁺) and oxygen gas. As a result of the applied electric field, the hydronium migrates through cation exchange barrier 50 into eluent generation chamber 16 where the hydronium combines with methane sulfonate anions to generate the MSA eluent.

The solution exiting eluent generation chamber, 16 is the newly formed MSA eluent which flows via conduit 18 to injection valve 20 and then to chromatographic separator 22 e.g. a chromatography column in which ions of one charge, positive or negative, are separated). From the separator 22 the MSA eluent enters via conduit 24, into suppression chamber 26. Suppressor chamber 26 contains high capacity anion exchange material, 327 which suppress (i.e., neutralizes) the MSA eluent to water. In the suppression reaction, methane sulfonated anions are exchanged for hydroxide in the high capacity anion exchange material 327. In cathode chamber 38, water is electrolyzed (reduced) to hydroxide (OH⁻) and hydrogen gas at cathode 40. As a result of the applied electric field, the hydroxide ions migrate through anion exchange barrier 42 and into suppression chamber 26. For every equivalence of hydroxide ion produced, an equivalence of methane sulfonate ion exits suppression chamber 26, through anion exchange barrier 45 and into eluent generation chamber 16 where the methane sulfonate ions can be used to produce MSA eluent. Hence, the methane sulfonate ion is continually refluxed between suppression chamber 26 and eluent generation chamber 16. For every equivalence of hydroxide ions produced in cathode chamber 38, there is an equivalence of hydronium ions produced in anode chamber 46, which results in the stoichiometrically linked eluent generation and suppression reactions.

The suppressed eluent exits suppression chamber 26 via conduit 28 where ions are detected via conductivity cell 30. More specifically, as illustrated for cation analysis in FIG. 4, the suppressed eluent exits conductivity cell 30 via conduit 32 to the inlet of cathode chamber 38. This suppressed eluent serves as the source of water for the electrolysis reaction at cathode 40 which produces the hydroxide ion used for the suppression reaction in suppression chamber 26. The suppressed eluent (now containing hydrogen gas) exits cathode chamber 38 via conduit 34 and the flow is directed to anode chamber 46. In anode chamber 46, the suppressed eluent serves as the source of water for the electrolysis reaction at anode 48 which produces the hydronium used for the eluent generation reaction in eluent generation chamber 16. The suppressed eluent (now containing hydrogen and oxygen gases) exits anode chamber 46 via conduit 36 and is directed to waste.

The anode chamber 46 contains an anode 48 which is electrically connected with cathode 40 in cathode chamber 38. A power supply connected to electrodes 48 and 40 creates electrodes of opposite charge and a current is passed between the electrodes through all barriers and chambers of the device. As illustrated, electrode 48 is an anode and electrode 40 is a cathode. Anode 48 is separated from eluent generation chamber 16 by barrier 50 illustrated as a cation exchange membrane of opposite charge to anion exchange membrane 42 adjacent to cathode chamber 38.

The electrode rinse solution may be the suppressed eluent as illustrated in FIG. 4 wherein the suppressed eluent exits conductivity cell 30 via conduit 32 which directs flow to the cathode chamber 38 to conduit 34 and anode chamber 46 to conduit 36 and to waste. In an alternative configuration, not shown, the rinse water may flow in the opposite direction between chambers 46 and 38.

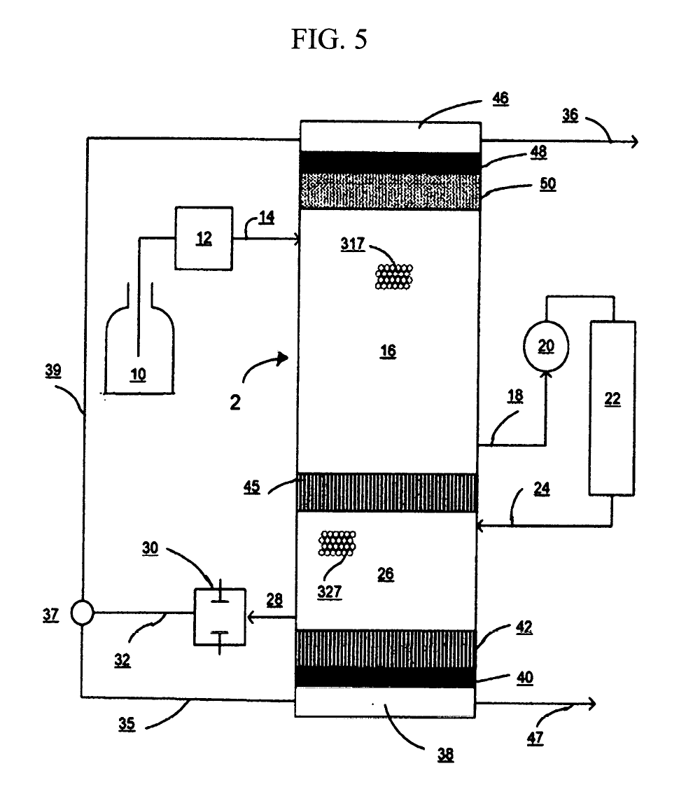

In FIG. 5, the suppressed eluent from conductivity cell 30 is directed to a flow through tee 37 which splits the flow. One outlet of the tee 37 is connected to anode chamber 46 via conduit 39 and to waste via conduit 36. The other outlet of the tee 37 is connected to cathode chamber 38 via conduit 35 and to waste via conduit 47. An advantage of a single stream flowing sequentially between the electrode chambers as depicted in FIG. 4 versus flowing in parallel as depicted in FIG. 5 is that the flow rate depicted in FIG. 4 is equal in both electrode chambers.

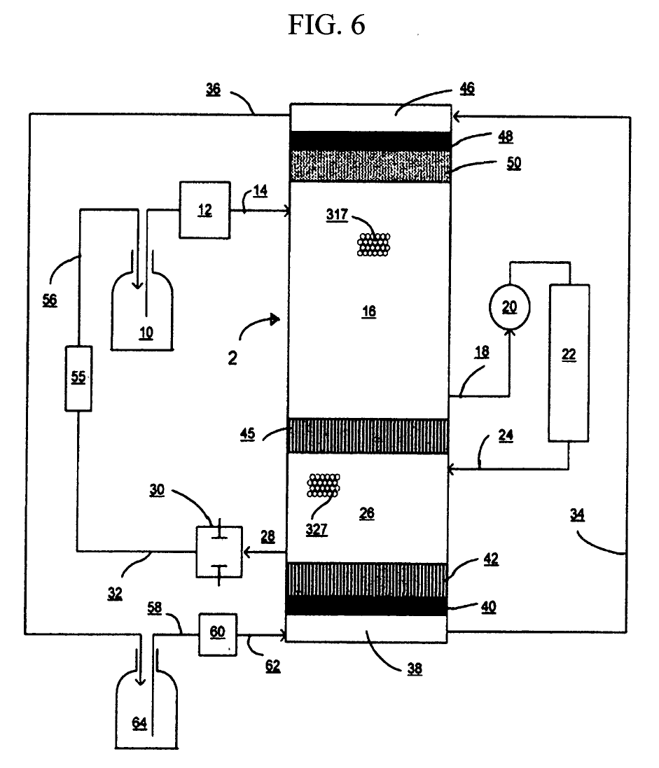

The ion reflux device 2 can be used in a pumped phase recycle mode. For cation analysis as shown in FIG. 6, the suppressed eluent exiting conductivity cell 30 via conduit 32 passes through cation trap column 55 to conduit 56 which returns the suppressed eluent to the deionized water source 10. The cation trap column 55 removes trace cations from the suppressed eluent and could contain high capacity cation exchange resin material in the hydronium form, e.g. in a packed bed, so that the lifetime of the trap could be very long. In addition to removing analytes from the recycled eluent, the cation trap column 55 could also be designed to trap cationic contaminants (amines and ammonia) from the aminated anion exchange materials of the suppression chamber 26 and eluent generation chamber 16. In this mode, the deionized water (pumped phase) will not contain oxygen, hydrogen and has no appreciable concentrations of electrochemical by-products and thus can recycled back to the deionized water source 10.

In FIG. 6, a second deionized water source is required for electrode rinse liquid. The electrode rinse liquid is typically deionized water and serves as a source of water for electrolysis to produce hydronium at the anode and hydroxide at the cathode. As shown in FIG. 6, an electrode rinse water source 64 is directed to a pump, 60 via conduit 58 and the pump outlet conduit 62 directed to the fluid inlet of cathode chamber 38 and to conduit 34 which directs flow to anode chamber 46 and then to conduit 36 which directs the electrode rinse water back to the source 64. In this way, the electrode rinse solution is recycled. The electrode rinse water source 64 is vented to prevent the accumulation of hydrogen and oxygen gases from the electrolysis of the water. In the system of FIG. 6 all liquids are recycled as well as the methane sulfonate for eluent generation. This system is ideally suited for long-term operation where minimal user intervention is required.

In the device of FIG. 1, analyte anions in the suppressed eluent exiting conductivity cell 30 pass through anode chamber 46 and cathode chamber 38. To prevent analyte anions from entering eluent generation 16 from cathode chamber 38 though anion exchange barrier 42, an anion trap column 54 (not shown) can be placed in-line with conduit 32 or 34. In FIG. 2, an anion trap column 54 (not shown) can be placed in-line with conduit 39 to prevent analyte anions from entering eluent generation chamber 16 through anion exchange membrane 42.

In the device of FIG. 4, analyte cations in the suppressed eluent exiting conductivity cell 30 pass through cathode chamber 38 and anode chamber 46. To prevent analyte cations from entering eluent generation 16 from anode chamber 38 though cation exchange barrier 50, a cation trap column 55 (not shown) can be placed in-line with conduit 32 or 34. In FIG. 5, a cation trap column 55 (not shown) can be placed in-line with conduit 39 to prevent analyte cations from entering eluent generation chamber 16 through cation exchange membrane 50.

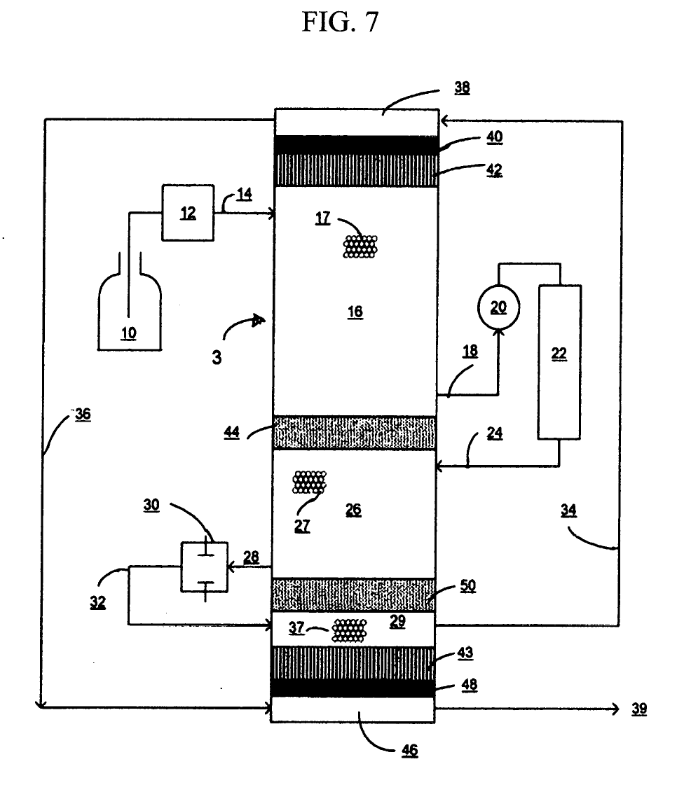

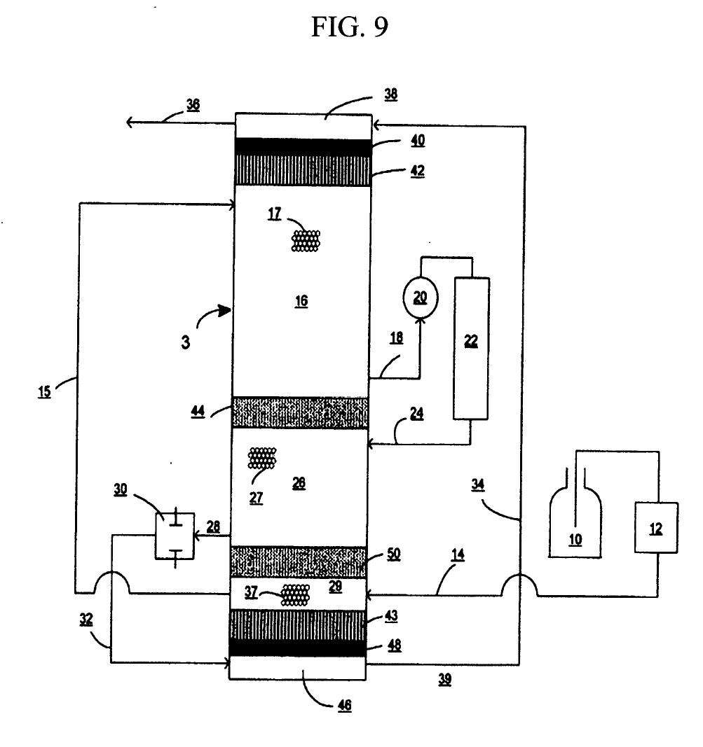

In device 3 of FIG. 7, an ion removal chamber 29 containing anion exchange resin or a composite ion exchange material consisting of a mixture of anion and cation exchange resin, 37 is integrated into the device. Ion removal chamber 29 is disposed between anode chamber 46 and suppressor chamber 26. The suppressed eluent containing analyte ions flows from suppressor chamber 26 through conductivity cell 30 and to conduit 32 and into analyte removal chamber 29 which is bounded on one side of the anode chamber 46 by anion exchange membrane 43. Cation exchange membrane barrier 50 separates analyte ion removal chamber 29 from suppressor chamber 26. As illustrated, the analyte anions are transmitted across anion exchange Membrane 43 and into anode chamber 46. Thus, the solution exiting analyte removal chamber 29 in conduit 34 has been purified of the analyte anions and is a pure water source for the electrolytic suppression and eluent generation reactions. Ion removal chamber 29 eliminates the need for an external anion trap column 54 shown in FIG. 3. In device 3 of FIG. 9, deionized water from source 10 is delivered by pump 12 through the ion removal chamber 29 to remove any trace anions and dissolved carbon dioxide (carbonate) from the deionized water and then into the eluent generation chamber 16.

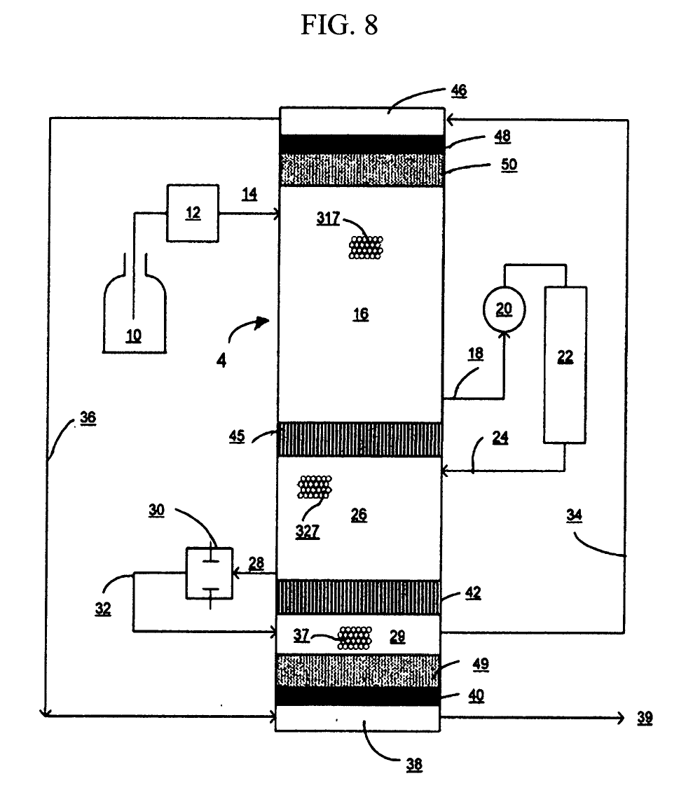

In FIG. 8, an ion removal chamber 29 containing cation exchange resin or a composite ion exchange material consisting of a mixture of anion and cation exchange resin, 37, is integrated into device 4. Ion removal chamber 29 is disposed between cathode chamber 38 and suppressor chamber 26. The suppressed eluent containing analyte cations flows from suppressor chamber 26 through conductivity cell 30 and to conduit 32 and into ion removal chamber 29 which is bound on one side of cathode chamber 38 by cation exchange membrane barrier 49. Anion exchange membrane barrier 42 separates analyte ion removal chamber 29 from suppressor chamber 26. As illustrated, the analyte cations are transmitted across cation exchange membrane 49 and into cathode chamber 38. Thus, the solution exiting ion removal chamber 29 in conduit 34 has been purified of the analyte cations and serves as a deionized water source for the electrolytic suppression and eluent generation reactions. Ion removal chamber 29 eliminates the need for an external cation trap column 55 described for FIG. 6.

Most samples for anion analysis will contain alkali and alkaline-earth metals. These cations may accumulate in the eluent generator chamber 16 and suppressor chamber 26 of device 1 of FIGS. 1, 2 and 3 and device 3 of FIG. 7 and eventually cause adverse chromatographic effects such as poor peak symmetry, reduced peak response and poor recovery. For samples high in cations such as sodium, potassium, ammonium, calcium and magnesium, the sample cations may need to be removed prior to injection. For manual sample injection, this could be accomplished using a cation exchange column in the potassium (eluent ion) for sample pretreatment prior to separation. When using an autosampler, a cation trap column (eluent ion form) could be placed between the autosampler and an injection valve. In FIGS. 1, 2 and 3 a cation trap column 55 (not shown) in the eluent ion form (potassium) may also be placed in-line with conduit 18 or between injection valve 20 and separator column 22 to exchange sample cations for potassium. The cation trap would have to be periodically replaced or regenerated depending on the sample injection volume as well as the concentration of cations in the sample.

Most samples for cation analysis will contain commons anions such as chloride and sulfate. These anions may accumulate in the eluent generator chamber 16 and suppressor chamber 26 of device 2 of FIGS. 4, 5 and 6 and device 4 of FIG. 8 and eventually cause adverse chromatographic effects such as poor peak symmetry, reduced peak response and poor recovery. For samples high in anions such as chloride, sulfate and nitrate and organic acids, the sample anions may need to be removed prior to injection. For manual sample injection, this could be accomplished using an anion exchange column in the methane sulfonate form (eluent ion) for sample pretreatment prior to separation. When using an autosampler, an anion trap column (eluent ion form) could be placed between the autosampler and an injection valve. In FIGS. 4, 5 and 6 an anion trap column 54 (not shown) in the eluent ion form (such as methane sulfonate) may also be placed in line with conduit 18 or between injection valve 20 and separator column 22 to exchange sample anions for methane sulfonate. The anion trap would have to be periodically replaced or regenerated depending on the sample injection volume as well as the concentration of anions in the sample.

### EXAMPLES

A chambered ion reflux device for anion IC as depicted in FIG. 1 was constructed using machined poly etheretherketone (PEEK) hardware to retain the electrodes, membranes and resin. The internal flow dimensions of the suppression chamber were 0.40 cm in diameter and 1.3 cm in length. The suppressor chamber volume was approximately 160 μL. The internal flow dimensions of the eluent generation chamber were 0.80 cm in diameter and 3.8 cm in length with an internal volume of 1900 μL.

The anode chamber contained a platinum foil electrode. In contact with the anode and separating the anode chamber from the suppression chamber was a cation exchange membrane stack (Electropure Excellion I-100 cation exchange membrane, a product of Electropure Inc, Laguna Hills, Calif.). A portion of the suppression chamber closest to the anode chamber was filled with cation exchange resin (DOWEX™ 50x4 (100-200 mesh), a product of the Dow Chemical Company, Midland, Mich.) in the hydronium form. The remaining portion (50%) of the suppression chamber was filled with cation exchange resin (DOWEX™ 50x4 (100-200 mesh), a product of the Dow Chemical Company, Midland, Mich.) in the potassium form. A cation exchange membrane stack in the potassium form (Electropure Excellion I-100 cation exchange membrane, a product of Electropure Inc, Laguna Hills, Calif.) separated the suppression chamber from the eluent generation chamber.

The eluent generation chamber was filled with cation exchange resin (DOWEX™ 50x4 (100-200 mesh), a product of the Dow Chemical Company, Midland, Mich.) in the potassium form. Separating the eluent generation chamber from the cathode chamber is anion exchange membrane stack (Electropure Excellion I-200 anion membrane, a product of Electropure Inc, Laguna Hills, Calif.) The cathode chamber contained a platinum foil electrode. The cathode was in direct contact with the anion exchange membrane stack and cathode chamber.

The device of FIG. 1 was tested using a Dionex DX500 Ion Chromatography system (a product of Dionex Corp, Sunnyvale, Calif.) consisting of a GP50 pump, CD25A conductivity detector and a LC30 chromatography oven. An electrically controlled Rheodyne six port injection valve with a 20 μL injection loop was used for sample introduction. Deionized water (18.2 M-Ω) was used as the pumped phase and connected to the GP50 pump inlet. A Dionex AG15 anion separator (4 mm×50 mm) was used at a flow rate of 0.5 mL/min for the separation of the sample anions. An Agilent E3611A DC power supply (Agilent Corp., Santa Clara, Calif.) was used to power the chambered ion reflux device of FIG. 1 at a constant current of 25 mA and a voltage of 32V. Although the detector used in the instant invention can be based on other principles, a detector based on the principle of electrical conductivity is most preferred in the instant invention.

Deionized water was pumped to the eluent generator chamber of the ion reflux device at a flow rate of 0.5 mL/min. At 0.5 mL/min, the backpressure at the pump outlet was 460 psi. The AG15 contributed about 200 psi to the backpressure. The remaining backpressure was from the injection valve, ion reflux device and connecting tubing. From the outlet of the eluent generation chamber, the newly formed KOH hydroxide eluent flows to the injection valve and then to the AG15 separator and then to the inlet of the suppression chamber of the ion reflux device. The suppressor outlet is connected to the conductivity cell and then the conductivity cell liquid (suppressed eluent) flows to the anode chamber and then to the cathode chamber and to waste as shown in FIG. 1.

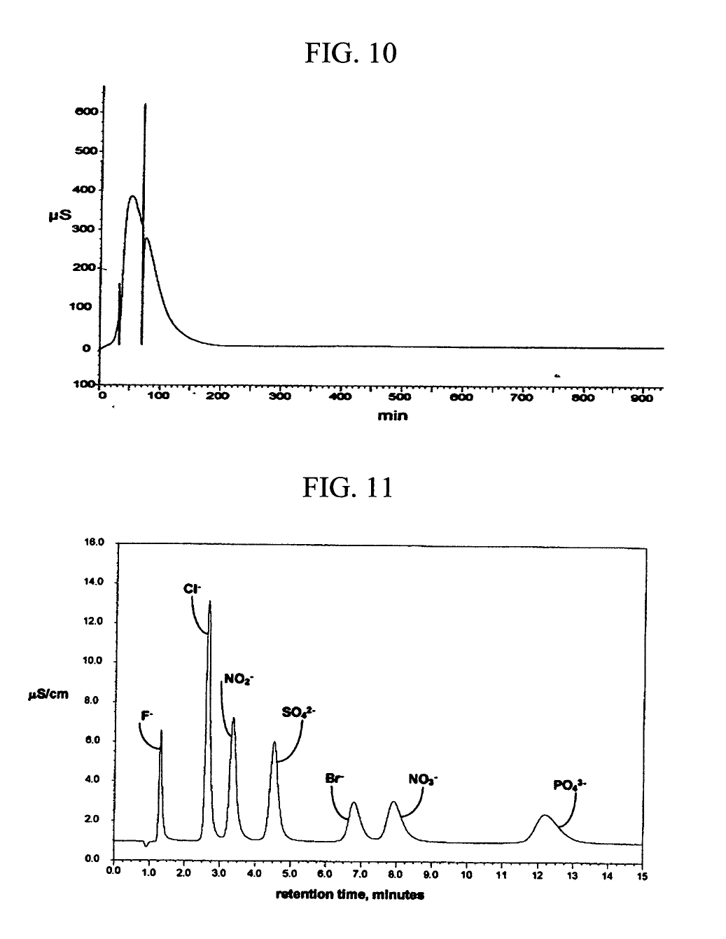

Data acquisition was started and collected for approximately 16 hours as the ion reflux device equilibrated as shown in FIG. 10. Initially the suppressed background conductivity was low (below 3 μS/cm), but began to increase at about 20 minutes as anionic contamination (chloride, sulfate and carbonate) from the anion exchange membrane stack (anion exchange barrier) separating the cathode chamber from the eluent generation chamber began to elute onto the separator column and finally to the conductivity cell. This start-up equilibration of the new device required about three hours of operation before the background conductivity stabilized to about 1.4 μS/cm. At a current of 25 mA and a flow rate of 0.5 mL/min, the theoretical eluent concentration would be approximately 31 mM KOH. The potassium ions in the suppressor chamber represent the maximum quantity of eluent available that will maintain a constant relationship between eluent generation and suppression. Assuming that half the suppressor chamber resin (0.080 mL of resin) was in the potassium form, and the capacity of the resin is 1.8 meq/mL, then there was approximately 0.14 meq of potassium ion available for eluent production and reflux. At a current setting of 25 mA and 0.5 mL/min, the theoretical eluent concentration generated is 31 mM (31 meq/L). Thus, there is sufficient potassium in the suppression chamber to generate approximately 4.5 mL of 31 mM KOH. While this is a relatively small volume of eluent, since the potassium ion is continually refluxed, the system can operate indefinitely without significant loss of eluent ions (K⁺).

Using the device of FIG. 1 and the conditions used for FIG. 10, a 20 μL of an anion standard was injected and the chromatogram of FIG. 11 was generated. Table I specifies the standard used in the subsequent Figures and identifies the analytes by peak number. The retentions times, background conductivity and the analyte peak area/height are consistent with the chromatography obtained using conventional ion chromatography methods.

TABLE 1
Analyte Specifications

| Analyte | Peak Number | Concentration (mg/L) |
|---|---|---|
| Fluoride | 1 | 1 |
| Chloride | 2 | 5 |
| Nitrite | 3 | 5 |
| Sulfate | 4 | 5 |
| Nitrate | 5 | 5 |
| Bromide | 6 | 5 |
| Phosphate | 7 | 10 |

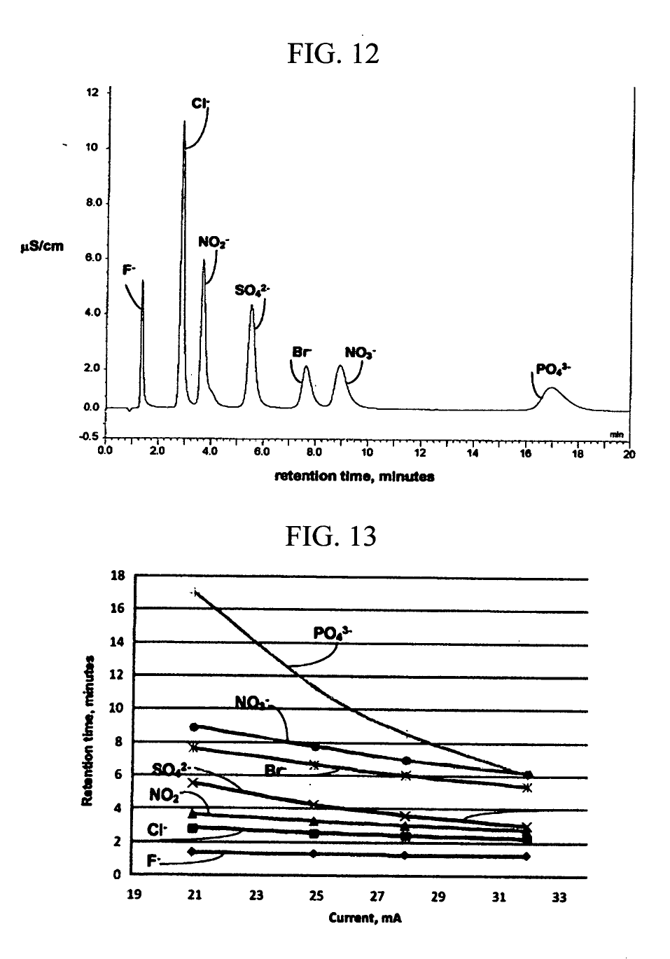

Since the eluent concentration generated in the ion reflux device is dependent on the applied current, changing the applied current should result in a retention time change. In FIG. 12 shows the chromatography obtained using the device of FIG. 1 with a pumped phase (deionized water) flow rate of 0.5 mL/min and a current of 21 mA. As predicted, retention time of all analytes increased since lower current results in a more dilute eluent.

In FIG. 13, the retention time of the seven analytes under different applied currents is shown. In FIG. 13, the theoretical KOH eluent concentration ranged from 26 mM (21 mA) to 40 mM (32 mA). As predicted, the polyvalent anions sulfate and phosphate exhibit the largest change in retention tines as a function of the current applied to the ion reflux device. The ability to change the applied current to the ion reflux device during a chromatographic run, allows for gradient elution. The applied current could be changed in a step-wise, linear, convex or concave fashion in order to achieve the desired chromatography. While the examples shown are under isocratic (constant current), it is obvious to one skilled in the art that gradient elution with the chambered ion reflux device is possible.

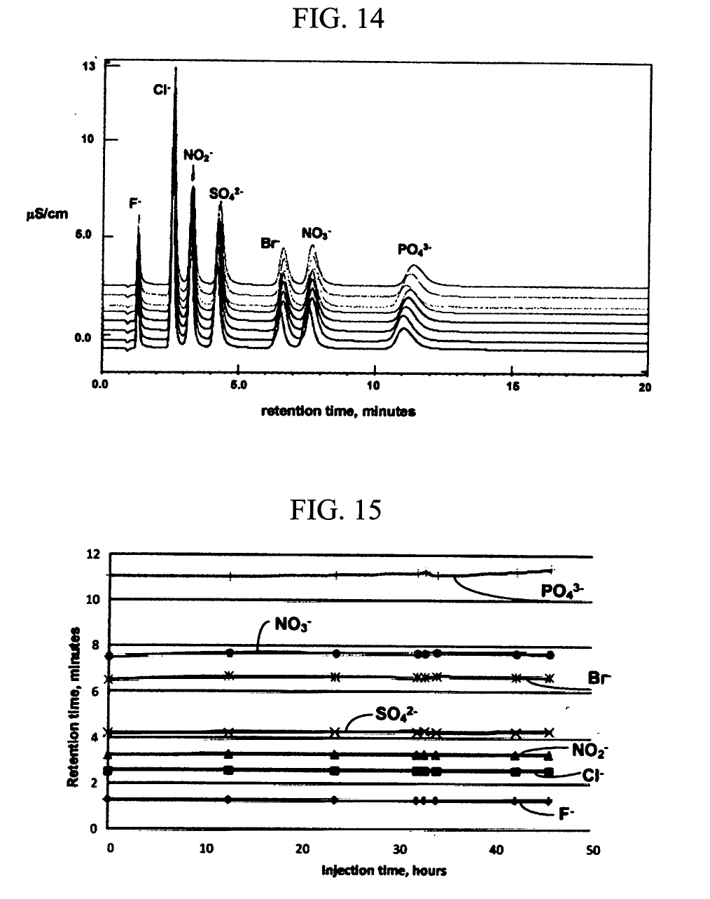

Since there is a finite mass of eluent ion in the ion reflux device, the long term stability of the device was investigated. Loss of eluent ion (potassium in these examples) will result in decreasing the eluent reservoir. If too much of the eluent ion is lost from the ion reflux device, then the relationship between applied current and eluent concentration will be compromised, resulting in non-reproducible chromatography. FIG. 14, shows an overlay of eight chromatograms obtained over 46 hours with a flow rate of 0.5 mL/min and with an applied current 25 mA. The retention time % relative standard deviation (% RSD) ranged from 0.41-1.1% for the seven analytes over the 46 hour period. This is well within the range of acceptable chromatographic performance. A plot of retention times vs injection time is shown in FIG. 15 for the conditions of FIG. 14.

While the examples shown are for anion analysis, the chambered ion reflux device of FIGS. 4, 5, 6 and 8 are applicable to cation analysis. In cation analysis, a methanesulfonic acid eluent would, for example, be generated with the anion exchange resin of the eluent generation chamber predominately in the methane sulfonate form and some portion of the anion exchange resin in the inlet region of the suppressor chamber is also in the methanesulfonate form.

What is claimed is:

1. A chambered ion reflux apparatus for ion chromatography comprising:
(a) a first electrode chamber comprising a first electrode and including an inlet and an outlet;
(b) an eluent generator chamber comprising ion exchange material and including an inlet and an outlet;
(c) a suppressor chamber comprising flow-through ion exchange material and including an inlet and an outlet;
(d) a second electrode chamber comprising a second electrode and including an inlet and an outlet;
(e) a first barrier preventing significant liquid flow, but permitting transport of ions of only one charge, positive or negative, disposed between said eluent generator chamber and said first electrode chamber;
(f) a second barrier preventing significant liquid flow, but permitting transport of ions of only one charge, positive or negative, disposed between said eluent generator chamber and said suppressor chamber;
(g) a third barrier preventing significant liquid flow, but permitting transport of ions of only one charge, positive or negative, disposed between said second electrode chamber and said suppressor chamber; and
(h) the outlet of the suppressor chamber being in liquid communication in a sequence selected from the group consisting of first through the anode chamber and then through the cathode chamber, first through the cathode chamber and then through the anode chamber and through both the anode chamber and the cathode chamber.

2. The apparatus of claim 1 further comprising
(i) a detector having an inlet and an outlet, the inlet of the detector being in liquid communication with the outlet of the suppressor chamber, the outlet of the detector being in liquid communication in a sequence selected from the group consisting of first through the anode chamber and then through the cathode chamber, first through the cathode chamber and then through the anode chamber and through both the anode chamber and the cathode chamber.

3. The apparatus of claim 2 further comprising
(j) an ion trap having an inlet and an outlet, the inlet of the ion trap being in liquid communication with the outlet of the detector, the outlet of the ion trap being in in liquid communication in a sequence selected from the group consisting of first through the anode chamber and then through the cathode chamber, first through the cathode chamber and then through the anode chamber and through both the anode chamber and the cathode chamber.

4. The apparatus of claim 3 in which said ion trap comprises an ion removal chamber comprising ion exchange material and including an inlet and an outlet, said ion removal chamber disposed between said suppression chamber and said second electrode chamber and a fourth barrier preventing significant liquid flow, but permitting transport of ions of only one charge, positive or negative, disposed between said ion removal chamber and said suppressor chamber.

5. The apparatus of claims 2, further comprising
(k) a chromatography separator including ion exchange material and having an inlet and an outlet, said separator outlet being in liquid communication with said suppressor chamber inlet, said eluent generator chamber outlet being in liquid communication with said separator inlet.

6. The apparatus of claim 3, further comprising
(k) a chromatography separator including ion exchange material and having an inlet and an outlet, said separator outlet being in liquid communication with said suppressor chamber inlet, said eluent generator chamber outlet being in liquid communication with said separator inlet.

7. The apparatus of claims 4, further comprising
(k) a chromatography separator including ion exchange material and having an inlet and an outlet, said separator outlet being in liquid communication with said suppressor chamber inlet, said eluent generator chamber outlet being in liquid communication with said separator inlet.

8. The apparatus of claim 1, in which said first and second barriers comprise exchangeable ions of opposite charge.

9. The apparatus of claim 2, in which said first and second barriers comprise exchangeable ions of opposite charge.

10. The apparatus of claim 3, in which said first and second barriers comprise exchangeable ions of opposite charge.

11. The apparatus of claim 4, in which said first and second barriers comprise exchangeable ions of opposite charge.

12. The apparatus of claim 5, in which said first and second barriers comprise exchangeable ions of opposite charge.

13. The apparatus of claim 6, in which said first and second barriers comprise exchangeable ions of opposite charge.

14. The apparatus of claim 7, in which said first and second barriers comprise exchangeable ions of opposite charge.

15. The apparatus of claim 4 in which said third and fourth barriers comprise exchangeable barriers of opposite charge.

16. The apparatus of claim 9 in which said second and fourth barriers comprise exchangeable ions of the same charge.

17. The apparatus of claim 10 in which said second and fourth barriers comprise exchangeable ions of the same charge.

18. The apparatus of claim 11 in which said second and fourth barriers comprise exchangeable ions of the same charge.

19. The apparatus of claim 12 in which said second and fourth barriers comprise exchangeable ions of the same charge.

20. The apparatus of claim 13 in which said second and fourth barriers comprise exchangeable ions of the same charge.

21. The apparatus of claim 14 in which said second and fourth barriers comprise exchangeable ions of the same charge.

22. The apparatus of claim 15 in which said second and fourth barriers comprise exchangeable ions of the same charge.

23. The apparatus of claim 4 in which the ion exchange material in said ion removal chamber comprises exchangeable ions selected from the group consisting of a positive charge, a negative charge, and a mixture of positive and negative charges.

24. The apparatus of claim 5, further comprising
(l) a liquid pump having an inlet and an outlet, the outlet of the pump being in liquid communication with the inlet of the eluent generation chamber; and
(m) a liquid reservoir containing deionized water, the inlet of the liquid pump being in liquid communication with the deionized water so that the deionized water can be pumped into the inlet of the eluent generation chamber.

25. The apparatus of claim 6, further comprising
(l) a liquid pump having an inlet and an outlet, the outlet of the pump being in liquid communication with the inlet of the eluent generation chamber; and
(m) a liquid reservoir containing deionized water, the inlet of the liquid pump being in liquid communication with the deionized water so that the deionized water can be pumped into the inlet of the eluent generation chamber.

26. The apparatus of claim 7, further comprising
(l) a liquid pump having an inlet and an outlet, the outlet of the pump being in liquid communication with the inlet of the eluent generation chamber; and
(m) a liquid reservoir containing deionized water, the inlet of the liquid pump being in liquid communication with the deionized water so that the deionized water can be pumped into the inlet of the eluent generation chamber.

27. An ion chromatography method using a chambered ion reflux device for ion chromatography comprising an eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first electrode chamber, and a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, said method comprising the steps of:
(a) flowing deionized water through said eluent generator chamber to generate an acid or base eluent;
(b) flowing said acid or base eluent through said suppressor chamber to neutralize said eluent to generate a neutralized eluent;
(c) flowing said neutralized eluent in a sequence selected from the group consisting of through first through the anode chamber and then through the cathode chamber, through the first the cathode chamber and then through the anode chamber and through both the anode chamber and the cathode chamber; and
(d) passing a current between said first and second electrodes through said eluent generator chamber and said suppressor chamber during steps (a) through (c).

28. The method of claim 27, further comprising the step between step (b) and step (c) of flowing the neutralized eluent through an ion trap.

29. An ion chromatography method using a chambered ion reflux device for ion chromatography comprising a eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first electrode chamber, a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, an ion removal chamber comprising ion exchange material disposed between said second electrode chamber and said suppression chamber, and a fourth barrier preventing significant liquid flow, but permitting transport of ions of only one charge, positive or negative disposed between said ion removal chamber and said suppressor chamber, said method comprising the steps of:
(a) flowing deionized water through said eluent generator chamber to generate an acid or base eluent;
(b) flowing said acid or base eluent through said suppression chamber to neutralize said eluent;
(c) flowing said neutralized eluent through said ion removal chamber and then in a sequence selected from the group consisting of through first through the anode chamber and then through the cathode chamber, through the first the cathode chamber and then through the anode chamber and through both the anode chamber and the cathode chambers; and
(d) passing a current between said first and second electrodes through said suppressor chamber, ion removal chamber, and eluent generator chamber, during steps (a) through (c).

30. An ion chromatography method using a chambered ion reflux device for ion chromatography comprising a eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first electrode chamber, a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, an ion removal chamber comprising ion exchange material disposed between said second electrode chamber and said suppression chamber, and a fourth barrier preventing significant liquid flow, but permitting transport of ions of only one charge, positive or negative, disposed between said ion removal chamber and said suppressor chamber, said method comprising the steps of:
(a) flowing deionized water from a first deionized water reservoir through said eluent generator chamber to generate an acid or base eluent;
(b) flowing said acid or base eluent through said suppression chamber to neutralize said eluent;
(c) flowing said neutralized eluent through said ion removal chamber and then back to said first deionized water reservoir;
(d) flowing deionized water from a second deionized water reservoir in a sequence selected from the group consisting of first through the anode chamber, then through the cathode chamber and then back to the second deionized water reservoir and first the cathode chamber, then through the anode chamber and then back to said second deionized water reservoir; and
(e) passing a current between said first and second electrodes through said suppressor chamber, ion removal chamber, and eluent generator chamber, during steps (a) through (d).

31. An ion chromatography method using a chambered ion reflux device for ion chromatography comprising an eluent generation chamber comprising ion exchange material and including an inlet and an outlet, a first electrode chamber comprising a first electrode and including an inlet and an outlet, a second electrode chamber comprising a second electrode and including an inlet and an outlet, a suppressor chamber comprising flow-through ion exchange material and including an inlet and an outlet, a first barrier preventing significant liquid flow, but permitting transport of ions of only one charge, positive or negative, disposed between said eluent generator chamber and said first electrode chamber, and a second barrier preventing significant liquid flow, but permitting transport of ions of only one charge, positive or negative, disposed between said suppressor chamber and said eluent generator chamber, a third barrier preventing significant liquid flow, but permitting transport of ions of only one charge, positive or negative, disposed between said second electrode chamber and said suppressor chamber, said method comprising the steps of:
(a) flowing deionized water from a first deionized water reservoir through said eluent generator chamber to generate an acid or base eluent;
(b) flowing said acid or base eluent through said suppression chamber to neutralize said eluent;
(c) flowing said neutralized eluent through an ion trap and then back to said first deionized water reservoir;
(d) flowing deionized water from a second deionized water reservoir in a sequence selected from the group consisting of first through the anode chamber, then through the cathode chamber and then back to the second deionized water reservoir and first the cathode chamber, then through the anode chamber and then back to said second deionized water reservoir; and
(e) passing a current between said first and second electrodes through said suppressor chamber, ion removal chamber, and eluent generator chamber, during steps (a) through (d).

32. A chambered ion reflux apparatus for ion chromatography of ions to be analyzed using an eluent comprising an ion or ions having the same charge as the ions to be analyzed and a counter-ion or counter-ions of opposite charge, said apparatus comprising:
(a) a first electrode chamber comprising a first electrode and including an inlet and an outlet;
(b) an eluent generator chamber comprising ion exchange material and including an inlet and an outlet;
(c) a suppressor chamber comprising flow-through ion exchange material and including an inlet and an outlet;
(d) a second electrode chamber comprising a second electrode and including an inlet and an outlet;
(e) a first barrier preventing significant liquid flow, but permitting transport of ions of only one charge, positive or negative, disposed between said eluent generator chamber and said first electrode chamber;
(f) a second barrier preventing significant liquid flow, but permitting transport of ions of only one charge, positive or negative, disposed between said eluent generator chamber and said suppressor chamber;
(g) a third barrier preventing significant liquid flow, but permitting transport of ions of only one charge, positive or negative, disposed between said second electrode chamber and said suppressor chamber; and
(h) wherein said flow-through ion exchange material of said suppression chamber adjacent said second barrier is in the ion form of the counter-ion or counter-ions of the eluent.

33. A chambered ion reflux apparatus for ion chromatography comprising:
(a) a first electrode chamber comprising a first electrode and including an inlet and an outlet;
(b) an eluent generator chamber comprising ion exchange material and including an inlet and an outlet;
(c) a suppressor chamber comprising flow-through ion exchange material and including an inlet and an outlet;
(d) a second electrode chamber comprising a second electrode and including an inlet and an outlet;
(e) a first barrier preventing significant liquid flow, but permitting transport of ions of only one charge, positive or negative, disposed between said eluent generator chamber and said first electrode chamber;
(f) a second barrier preventing significant liquid flow, but permitting transport of ions of only one charge, positive or negative, disposed between said eluent generator chamber and said suppressor chamber;
(g) a third barrier preventing significant liquid flow, but permitting transport of ions of only one charge, positive or negative, disposed between said second electrode chamber and said suppressor chamber; and
(h) an ion removal chamber comprising ion exchange material and including an inlet and an outlet, said ion removal chamber disposed between said suppression chamber and said second electrode chamber and a fourth barrier preventing significant liquid flow, but permitting transport of ions of only one charge, positive or negative, disposed between said ion removal chamber and said suppressor chamber, the outlet of the ion removal chamber being in liquid communication with the inlet of the eluent generation chamber.

34. The apparatus of claim 33 wherein the outlet of the suppressor chamber is in liquid communication in a sequence selected from the group consisting of first through the anode chamber and then through the cathode chamber, first through the cathode chamber and then through the anode chamber and through both the anode chamber and the cathode chamber.
